(19) United States
(12) Patent Application Publication
(10) Pub. No.: US 2008/0302485 A1
(43) Pub. Date: Dec. 11, 2008

(54) Mandrel for manufacturing hose

(76) Inventors: Gregory S. Mitsch, Woodbury, MN (US); Michael M. May, Stillwater, MN (US)

Correspondence Address: JOEL D. SKINNER, JR.;SKINNER AND ASSOCIATES, 212 COMMERCIAL ST., HUDSON, WI, 54016, US

(21) Appl. No.: 12/156,257

(22) Filed: May 29, 2008

Related U.S. Application Data
(60) Provisional application No. 60/932,001, filed on May 29, 2007.

(51) Int. Cl. B32B 37/00

(52) U.S. Cl. 156/391

(57) ABSTRACT

A mandrel for use in a crosshead extrusion process for manufacturing hose. The mandrel includes a core composed of a high tensile strength material; a tie layer disposed around and adhering to the core and an elongated cylindrical body disposed around the tie layer. The body is composed of a first thermoplastic material. An outer layer is disposed over the body. The outer layer has a predetermined thickness which is less than that of the body The outer layer is composed of a second thermoplastic material which is dissimilar to that of the first thermoplastic material. Methods of making and using the mandrel are also disclosed.

### CROSS-REFERENCE TO RELATED APPLICATIONS

This application claims the benefit under 35 U.S.C. §119(e) of co-pending U.S. Provisional Patent Application Ser. No. 60/932,001, filed May 29, 2007, which is hereby incorporated by reference.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND

1. Field.

The present invention relates, generally, to apparatus and methods of manufacturing hoses, particularly industrial and heavy duty hoses. Examples of such hoses include hydraulic, air conditioning, and power steering hoses. More particularly, the invention relates to mandrels for manufacturing hoses, and methods of making and using such mandrels. Most particularly, the invention relates to mandrels that have multiple layers of thermoplastic materials, the layers having different characteristics. The aspects of the invention may also be useful in other fields such as consumer, scientific, medical and other hoses, gaskets, seals and for other articles, apparatus and processes.

2. Background Information

Typically, industrial hoses are manufactured via a mandrel. In the hose making process, the mandrel is passed thru a cross-head die a layer of polymeric, rubber or other material is built up upon the mandrel. The materials have primarily been thermoset materials. The layer may include reinforcing material such as a wire or fabric, which may be braided. The mandrel defines and creates the inner diameter of the hose. The mandrel also serves to prevent collapse of the inner diameter during the layering or braiding operations. Once layering is completed, the hose is usually cured. Curing may involve placing the hose into a steam autoclave. After curing, the mandrel is pushed out of the hose, for example by way of high pressure water or other liquids. The mandrel may be reused for more than one manufacturing cycle.

Historically mandrels have been comprised of thermoset rubber materials or metal. More recently it is has become desired that these mandrels be recycled when they become unusable due to the cutting of defects out of the hose, dimensional change or for other reasons.

More recently thermoplastic materials have been used as mandrels. In all cases they have been comprised of a single material or a cross-head extruded mandrel over wire. While these mandrels work in some applications they do not serve to fulfill all the desired attributes or work in all hose constructions.

Existing technology is believed to have significant limitations and shortcomings, including high cost of materials, limited cycle duty, inability to incorporate recycled material, high friction and the like. A need exists for the present invention.

All US patents and patent applications, and all other published documents mentioned anywhere in this application are hereby incorporated by reference in their entirety.

### BRIEF SUMMARY

The present invention provides a mandrel, and methods of making and using the mandrel which are practical, reliable, accurate and efficient, and which are believed to fulfill a need and to constitute an improvement over the background technology.

One aspect of the invention is a mandrel comprising a body and an outer layer, wherein the body and the outer layer are constructed of dissimilar plastic materials.

A more specific aspect of the invention is a mandrel for use in a crosshead extrusion process for manufacturing hose, comprising an elongated cylindrical body of a predetermined diameter, the body being composed of a first thermoplastic material; and an outer layer disposed over the body, the outer layer having a predetermined thickness which is less than that of the body, the outer layer being composed of a second thermoplastic material which is dissimilar to that of the first thermoplastic material.

A still more specific aspect of the invention is a mandrel for use in a crosshead extrusion process for manufacturing hose, comprising a core composed of a high tensile strength material; a tie layer disposed around and adhering to the core; an elongated cylindrical body disposed around the tie layer, the body having a predetermined thickness and being composed of a first thermoplastic material; and an outer layer disposed over the body, the outer layer having a predetermined thickness which is less than that of the body, the outer layer being composed of a second thermoplastic material which is dissimilar to that of the first thermoplastic material.

The thermoplastic materials and plural layers employed in the mandrel and methods of the present invention provide significant advantages that no single material can provide, including low flexural modulus to permit bending and coiling, simultaneous high tensile strength so as not to stretch, and low co-efficient of friction to ease the blowout during use of the mandrel to manufacture hose. Simple incorporation of low coefficient of friction additives throughout the base polymer is not an acceptable solution to lowering the co-efficient of friction because such full scale incorporation increases the cost to an unacceptably high level.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

The present invention, and the manner and process of making and using it, will be better understood by those skilled in the art by reference to the following drawings.

FIG. 1 is a perspective view of an embodiment of a mandrel of the present invention, with its layers or elements partially peeled back to clarify the features thereof.

FIG. 2 is a side view of the mandrel.

FIG. 3 is an end view of the mandrel.

FIG. 4 is a longitudinal crossectional view of the mandrel.

FIG. 5 is an exploded view of the mandrel.

### DETAILED DESCRIPTION

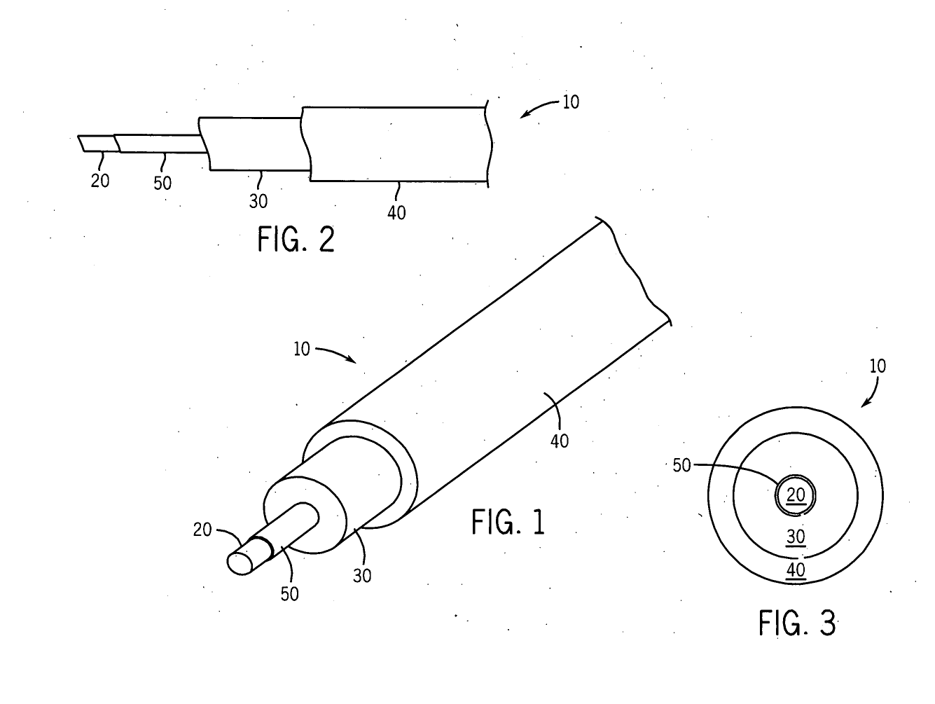

The mandrel of the present invention is particularly well suited for use in manufacturing hoses. Referring to FIGS. 1-3, one embodiment of the mandrel 10 has a cylindrical configuration with a predetermined outside diameter and length. The mandrel 10 has a layered construction a core 20, a body 30, and an outer layer 40. Preferably, a tie layer 50 is disposed between the core 20 and the body 30.

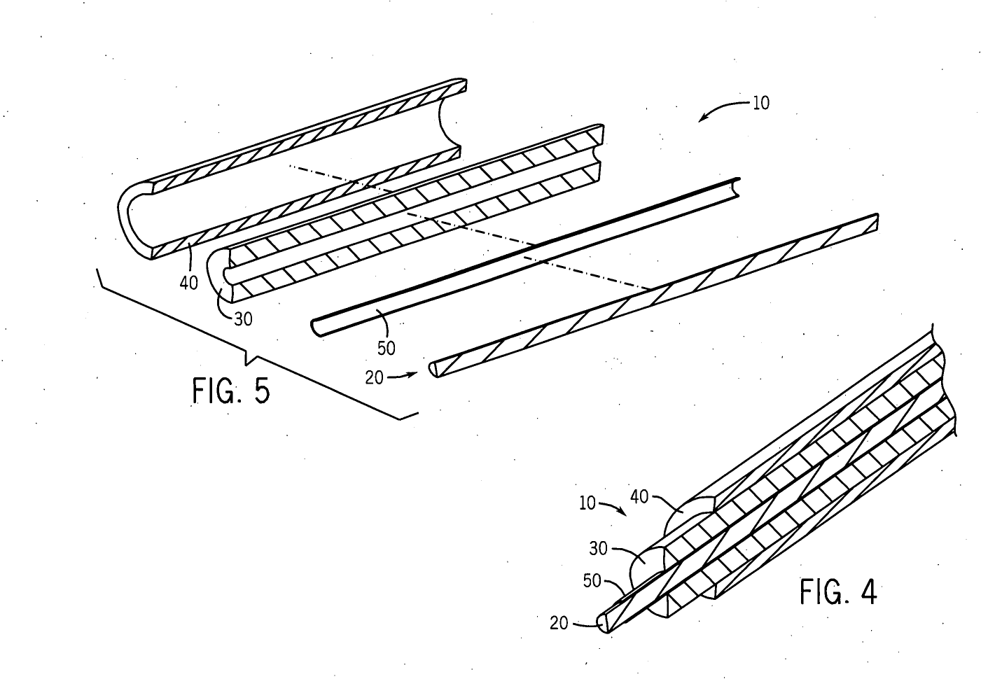

Referring also to FIGS. 4 and 5, the core 20 is preferably a wire or cable (stranded or unstranded) material with a substantially uniform cylindrical configuration. The core 20 is preferably a metal, and most preferably brass coated steel. The core 20 has a predetermined diameter, for example 0.070 inches. The body or body layer 30 is disposed over, for example by being built upon, the core 20. The body 30 is a natural or synthetic polymeric elastomer material, and preferably a thermoplastic polymer. Examples of thermoplastic polymers useable include Polymethylpentene (PMP), a blend or alloy of Ethylene Propylene Diene Monomer rubber (EPDM Rubber) and a Thermoplastic vulcanizate (TPV) (EPDM-TPV blend), a Low Coefficient of Friction EPDM-TPV (LCOF EPDM-TPV), and various mixtures thereof. PMP is available for example under the trademark TPX®. The body 30 material may be virgin or recycled (for example reground). The body 30 has a predetermined thickness built up over the core 20 and is the largest layer in this embodiment of the mandrel 10. The outer layer 40 is disposed over the body 30 and is the outer surface of this embodiment of the mandrel 10. The outer layer 40 is a natural or synthetic material and may be a thermoset polymer of the same composition of the body 30 or a variant thereof. It may be a virgin or recycled material. Alternatively, the outer layer 40 may be a low co-efficient of friction material such as TEFLON® or equivalent material, preferably a melt processable material. The outer layer 40 has a predetermined thickness which is less than that of the body 30.

The structural combination of the core 20, body 30 and outer layer 40 provides a mandrel 10 that has: (1) balanced (a) flexibility and (b) high tensile strength, (2) dimensional stability, (3) tight dimensional control, (4) a low coefficient of friction, and (5) increased durability and hose manufacture duty cycles. This structure also permits use of recycled materials to manufacture mandrels at lower cost.

The embodiment of the mandrel 10 preferably also has a tie or adhesion layer 50 between the core 20 and the body 30. The tie layer 50 is a high temperature polymeric material. The tie layer 50 improves adhesion of the body 30 material and the core 20. The increased bond is beneficial for blocking water from going up the wire (core 50) during a blowout step of using the mandrel 10 to make a hose. The tie layer 50 may be thin, and may be a coating, dip, spray or the like.

An alternative embodiment of the mandrel has a solid body with no core. the body is constructed entirely of thermoplastic material. The outer layer is then disposed over the body. The outer layer is constructed of a material which is dissimilar to that of the body.

Mandrel embodiments may be varied consistent with the basic teachings of the invention. Example alternative structural combinations for the mandrel include:
Stranded cable core 20, tie layer 50, low cost thermoplastic material body 30, outer layer 40 of low co-efficient of friction material.
Stranded cable core 20, tie layer 50, recycled (regrind) thermoplastic body 30, outer layer 40 of virgin higher cost thermoplastic material or low co-efficient of friction material.
The body 30 embodiments discussed above, with or without a core, may include varying mixtures of recycled and virgin compounds. Dissimilar outer layers 40 are disposed over the body 30.

An embodiment of a method of making the mandrel 10 yields high quality, durable, and tightly dimensionally controlled mandrels. The method preferably is made by crosshead extrusion. Crosshead extrusion involves running a core through a crosshead die of a crosshead extrusion line. A tie layer or material may be applied to the core. A body is extruded over the core or core and tie layer with a thermoplastic polymer. The body is built up to a hardness of between 80 and 95 Shore A. The built up materials are then cooled to final dimensions. The mandrel is then passed through a measurement system, for example an optical measurement system, to inspect quality. The mandrel is then traverse wound on a spool, for example in lengths of between 7,000-10,000 feet (at 0.365 inch mandrel diameter).

The mandrel may alternatively be made by coextrusion wherein materials are formed inside a coextrusion die, and then cooled and packaged outside the die.

An embodiment of a method of using the mandrel 10 of the present invention to make a hose involves cross head extrusion. A mandrel is inserted into a crosshead die. Polymeric hose body material is then extruded onto the mandrel. Reinforcing material may be added to the polymer by braiding. The mandrel/hose combination is extruded to a predetermined outer diameter and length. The length of the mandrel/hose combination may be on the order of 2000 feet. The mandrel/hose combination is then cured, for example in a steam autoclave. After curing, the mandrel is pushed out of the hose via high pressure water or other liquids. The mandrel may be reused for more than one manufacturing cycle. After a predetermined number of hose manufacture cycles, the mandrel may be ground and the polymeric material may be used to make a new, recycled, mandrel.

The flexibility of the multi-layer, thermoplastic mandrel 10 allows coiling during curing by steam autoclave. The high tensile strength of the mandrel 10 prevents stretching or necking down in the braiding step. The mandrel 10 dimensional stability permits repeated heat cycles in the autoclave. Tight dimensional control (as low as +/−0.002″) of the mandrel 10 (OD) yields near perfect inner hose diameters (ID). And, the low coefficient of friction of the mandrel 10 makes it easier to blow manufactured hose off of the mandrel 10, particularly at lower pressures and longer lengths, at the conclusion of a hose manufacturing cycle. The multi-layered thermoplastic mandrel 10 is also useable for substantially more duty cycles. And at the conclusion of its useful life it may be ground and its materials recycled for use in the body layer or outer layers of new mandrels. Other benefits and advantages of the mandrel and processes of the invention include, but are not necessarily limited to:
Materials are melt compatible to allow for recycling of materials.
Reduced cost by use of recycled, regrind, mandrel material.
Reduced cost by eliminating high slip additives through out the mandrel.
A slippery outer skin allows for easier blow-out in general.
A slippery outer skin allows for blow-out at lower pressure.
A slippery outer skin allows for easier blow-out at longer lengths.
A slippery outer skin eliminates need for additional lubricants to be put on the surface prior to hose building process reducing cost, defects caused by lubricants to the hose.

Although the articles, apparatus and methods have been described in connection with applications the field of hoses, it can readily be appreciated that they are not limited solely to such field, and can be used in other fields.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A mandrel comprising a body and an outer layer, wherein the body and the outer layer are constructed of dissimilar plastic materials.

2. The mandrel of claim 1, wherein the mandrel has an elongated cylindrical configuration and is adapted for use in manufacturing hose.

3. The mandrel of claim 1, wherein the mandrel further comprises a core disposed within the body.

4. The mandrel of claim 3, wherein the core is a metal wire.

5. The mandrel of claim 4, wherein the wire is brass coated stainless steel.

6. The mandrel of claim 3, wherein the core is a metal cable.

7. The mandrel of claim 3, further comprising a tie layer disposed between the core and the body, the tie layer facilitating adhesion between the core and the body.

8. The mandrel of claim 1, wherein the body is composed of a first thermoplastic material.

9. The mandrel of claim 8, wherein the outer layer is composed of a second thermoplastic material.

10. The mandrel of claim 8, wherein the outer layer is composed of a low coefficient of friction material.

11. The mandrel of claim 10, wherein the low coefficient of friction material includes TEFLON.

12. The mandrel of claim 1, wherein the plastic materials are selected from the group consisting of Polymethylpentene (PMP), a blend or alloy of Ethylene Propylene Diene Monomer rubber (EPDM Rubber) and a Thermoplastic vulcanizate (TPV), a Low Coefficient of Friction EPDM-TPV (LCOF EPDM-TPV), and various mixtures thereof.

13. The mandrel of claim 1, wherein the body is composed of recycled plastic material and the outer layer is composed of virgin plastic material.

14. The mandrel of claim 1, wherein the body has a predetermined thickness and wherein the outer layer has a predetermined thickness which is less than that of the body.

15. A mandrel for use in a crosshead extrusion process for manufacturing hose, comprising:
a. an elongated cylindrical body of a predetermined diameter, the body being composed of a first thermoplastic material; and
b. an outer layer disposed over the body, the outer layer having a predetermined thickness which is less than that of the body, the outer layer being composed of a second thermoplastic material which is dissimilar to that of the first thermoplastic material.

16. The mandrel of claim 15, wherein the mandrel further comprises a core disposed within the body.

17. The mandrel of claim 16, further comprising a tie layer disposed between the core and the body, the tie layer facilitating adhesion between the core and the body.

18. The mandrel of claim 17, wherein the outer layer includes a low coefficient of friction material.

19. The mandrel of claim 15, wherein the first and second thermo plastic materials are selected from the group consisting of Polymethylpentene (PMP), a blend or alloy of Ethylene Propylene Diene Monomer rubber (EPDM Rubber) and a Thermoplastic vulcanizate (TPV), a Low Coefficient of Friction EPDM-TPV (LCOF EPDM-TPV), and various mixtures thereof.

20. A mandrel for use in a crosshead extrusion process for manufacturing hose, comprising:
a. a core composed of a high tensile strength material;
b. a tie layer disposed around and adhering to the core;
c. an elongated cylindrical body disposed around the tie layer, the body having a predetermined thickness and being composed of a first thermoplastic material; and
d. an outer layer disposed over the body, the outer layer having a predetermined thickness which is less than that of the body, the outer layer being composed of a second thermoplastic material which is dissimilar to that of the first thermoplastic material.
